(19) United States
(12) Patent Application Publication
(10) Pub. No.: US 2024/0424701 A1
(43) Pub. Date: Dec. 26, 2024

(54) Shaver with Replaceable Cartridge

(71) Applicant: Universal Beauty Products, Inc., Glendale Heights, IL (US)

(72) Inventor: Yong C. Park, Glendale Heights, IL (US)

(21) Appl. No.: 18/750,707

(22) Filed: Jun. 21, 2024

Related U.S. Application Data
(60) Provisional application No. 63/509,327, filed on Jun. 21, 2023.

(51) Int. Cl. B26B 21/52; B26B 21/18

(52) U.S. Cl. CPC B26B 21/521; B26B 21/18

(57) ABSTRACT

A handheld cartridge shaver in the style of a safety razor including a handle, a head positioned onto the handle to be substantially perpendicular to a longitudinal axis of the handle, and a cartridge for releasable attachment to the head. The cartridge includes at least one double-edged blade and provides dual shaving edges. Preferably, the cartridge comprises multiple disposable double-edged blades. The razor further includes a mechanism for securing and releasing the cartridge from the head. In alternate embodiments, the mechanism includes a release button positioned within the handle or positioned within the head.

### RELATED APPLICATION

The present application claims the filing priority of U.S. Provisional Application No. 63/509,327, titled “Shaver With Replaceable Cartridge” and filed on Jun. 21, 2023. The '327 application is hereby incorporated by reference.

### TECHNICAL FIELD OF THE INVENTION

The present invention relates to manual shavers using a replaceable (aka, disposable) razor cartridge. More specifically, the invention relates to a safety-razor style with a replaceable razor cartridge.

### BACKGROUND OF THE INVENTION

The history of the double-edge safety razor is as Americana as you can get. The classic double-edge safety razor was invented and patented by King Camp Gillette in 1904 . . . see U.S. Pat. No. 775,134. The sharpened, stamped-steel, double blade razor was a radical departure from a straight razor used by men to shave in those days. The safety razor was extremely popular, and that popularity was greatly enhanced as a result of being issued by the U.S. military to all its soldiers during World War I. With a handle and a light disposable blade, shaving was quick and efficient. It made sense to carry one in a mess kit versus using a straight razor with all the necessary accessories.

When most men returned from the war, they maintained the practice of wet shaving with a double-edge razor. However, over time the safety razor has declined in popularity in favor of pivoting head cartridge razors, disposable razors, and the rotating blades of electric razors-all tools that were marketed as convenient and easy.

Cartridge razors were invented in the early 1970's and were regarded as providing a smoother and more comfortable shave. Wilkinson Sword Company began selling single edge blades imbedded in a plastic disposable cartridge. Shortly thereafter, Gillette added a second blade to its version of the cartridge razor, claiming a smoother shave. Since that time, the cartridge razor has evolved from plastic bodies and handles with a single surgical-steel blade to complex shaving systems with curved handles, multiple flexible blades (3, 4, and 5 blades), multiple cartridge packs, comfort strips, and some even provide vibration and heat. Cartridge razors were popularized not only for the case of use, but also for the claim that they provided a smooth, comfortable shave.

Present day handheld shaving systems combine the benefits of a replaceable cartridge with the traditional look and style of a safety razor. Until the invention of the present application, these and other problems in the prior art went either unnoticed or unsolved by those skilled in the art. The present invention provides a unique shaving device which performs like a cartridge razor without sacrificing design, style, or affordability.

### SUMMARY OF THE INVENTION

There is disclosed herein an improved safety razor which avoids the disadvantages of prior devices while affording additional structural and operating advantages.

Generally speaking, the shaver comprises a handle, a head positioned onto the handle to be substantially perpendicular to a longitudinal axis of the handle, and a cartridge containing a disposable double-edged safety razor blade, the cartridge being releasably attached to the head.

In specific embodiments, the head comprises a first coupling member and the cartridge comprises a body having first and second slit openings on opposing edges, and a second coupling member functionally corresponding to the first coupling member for releasable attachment of the cartridge to the head

In specific embodiments, the first and second coupling members are comprised of protrusions and recesses, respectively. Alternatively, the first and second coupling members are comprised of recesses and protrusions, respectively.

Specific embodiments of the shaver may further comprise a release mechanism for detaching the cartridge from the head. Wherein, the release mechanism may comprises one of either an actuator button and a movable mechanism to force the cartridge from the head of the shaver, or an actuator button and a movable mechanism for securing and releasing the cartridge from the head.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view of an embodiment of the disclosed handheld shaver;

FIG. 2 is a front view of the handheld shaver shown in FIG. 1;

FIG. 3 is a perspective view of the handheld shaver of FIG. 1 showing the blade cartridge removed from the razor head;

FIG. 4 is a top view of a double-edged razor blade and an embodiment of a blade cartridge for the disclosed handheld shaver;

FIG. 5 is a front plan view of an embodiment of the disclosed shaver;

FIG. 6 is side view of the shaver of FIG. 5;

FIG. 7 is a perspective view of the shaver of FIG. 5;

FIG. 8 is a cross-sectional view through A-A of FIG. 5;

FIG. 9 is a sequence of four steps illustrating an embodiment of the attachment and discharge process for the blade cartridge to a shaver head;

FIG. 10 is a close-up view of an embodiment of the handheld shaver head showing a release mechanism for disengaging the cartridge from the shaver head;

FIG. 11 is a close-up view of another embodiment of the handheld shaver head showing a release mechanism for securing and releasing the cartridge to and from the shaver head;

FIG. 12 is a top view of another embodiment of a blade cartridge for the disclosed handheld shaver;

FIG. 13 is a front plan view of an embodiment of the disclosed shaver;

FIG. 14 is side view of the shaver of FIG. 13;

FIG. 15 is a perspective view of the shaver of FIG. 13;

FIG. 16 is a cross-sectional view through A-A of FIG. 13; and

FIG. 17 is a sequence of four steps illustrating an embodiment of the attachment and discharge process for the blade cartridge to a shaver head.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

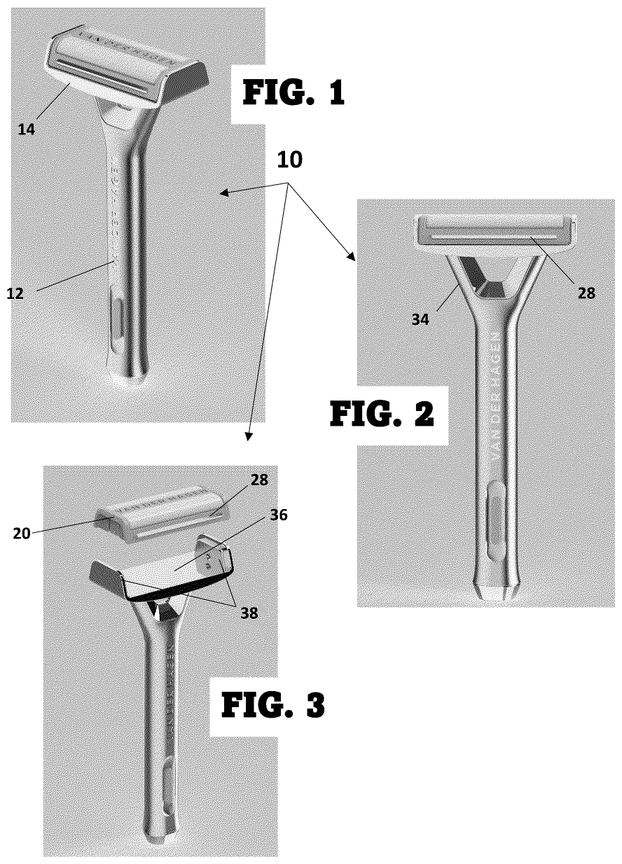

Referring to FIGS. 1-17, there is illustrated at least one embodiment of a shaver, generally designated by the numeral 10. The particular illustrated shaver 10 preferably includes a razor handle 12, a shaver head 14, and a replaceable blade cartridge 20. The cartridge 20 includes a replaceable double-edged razor blade 16, and is removably seated within the shaver head 14 during use.

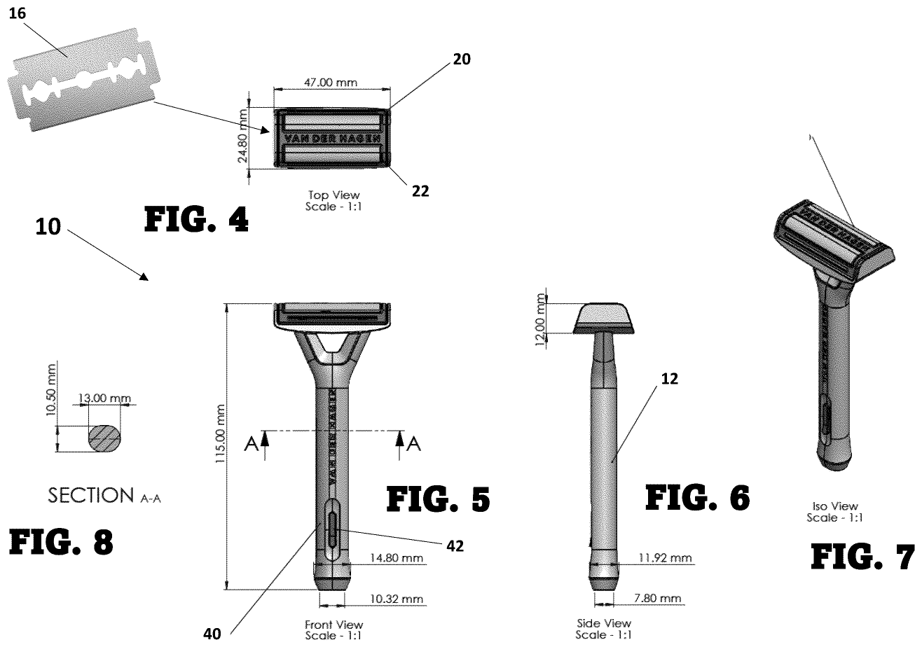

The cartridge 20 is comprised of a molded plastic body 22 having a base surface and an upper surface. Two slit openings 28 exist on two lateral sides of the cartridge 20. At least one double-edged razor blade 16 is positioned within the plastic molded body 22 (see FIG. 4). It is contemplated that the razor blade 16 may be placed into the body through one of the slip openings 28 or through another opening (not shown) within the molded plastic body 22. When properly positioned in the body 22, each cutting edge of the blade is exposed through one of the slip openings 28 to provide a shaving surface for the cartridge 20. Unlike conventional cartridge shavers, this allows the present shaver 10 to shave in both directions (e.g., a downward stroke and an upward stroke) without repositioning the shaver 10 in the user's hand.

As described more fully below, the cartridge 20 is secured to the head by first coupling members 30 (e.g., recesses) positioned on each cartridge 20 so as to be easily engaged and retained by corresponding second coupling members 32 on the shaver head 14 (e.g., protrusions).

As can be seen in FIGS. 1-8, an embodiment of the shaver 10 is shown to be comprised of a cylindrical handle 12 which forks into a support 34 for a cartridge holding head 14 of the shaver 10. The head 14, which sits in a plane substantially perpendicular to the longitudinal axis of the handle 12, includes a base surface 36 and vertical sides 38. The base 36 and/or sides 38 are configured with second coupling members 32 to engage and retain a cartridge 20 in the shaver head 14 for proper shaving. There are many variations on the means by which the cartridge 20 is retained within and ejected from the shaver head 14. For example, the cartridge 20 may be friction fit into the head 14, retained in a track, held by a mechanism, or any other means known and used by those of skill in the art.

The first and second coupling members 30, 32 in the embodiment of FIGS. 1-3 are preferably comprised of a combination of small protrusions (or the like) on an inner surface of the sides 38 of the shaver head 14, which friction or snap-fit within corresponding recesses on the cartridge 20, or vice-versa. The cartridge 20 can be readily “popped” in and out of engagement with sufficient force directed upward on the cartridge. This prevents the cartridge 20 from being accidentally released while shaving.

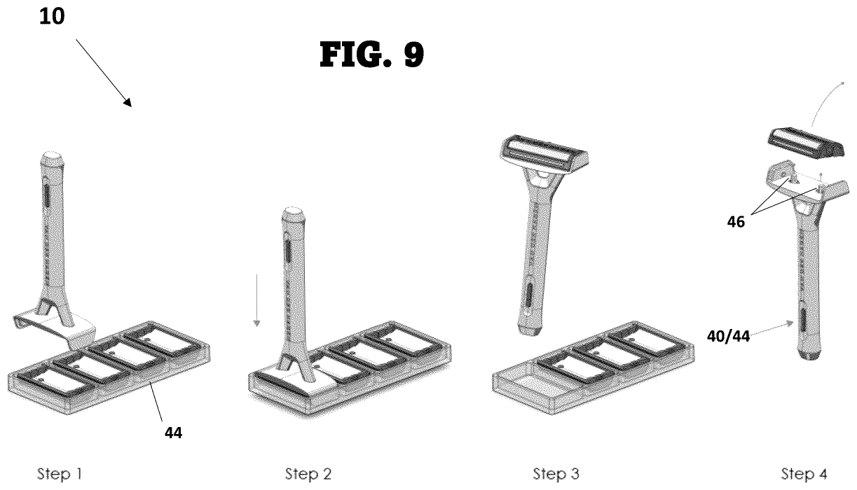

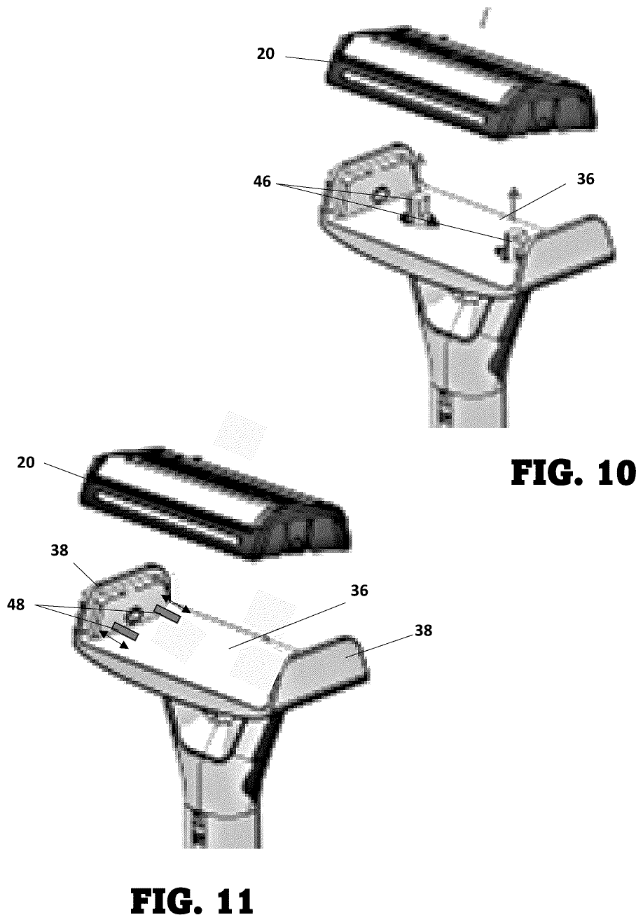

In the embodiment of FIG. 9, a release mechanism 40—for example, a push-button, slide-release, or similar mechanism—may be used for actuating devices such as coupling members 32 positioned within the shaver head 14. In one embodiment illustrated in FIG. 10, the release mechanism 40 is used to push or otherwise discharge the cartridge 20 from a seated position in the shaver head 14. This is most effective when the cartridge 20 is friction fit within the head 14. Alternatively, referring to FIG. 11, coupling members 32 may be actuated to move inward and outward (or up and down) to grip and release the cartridge 20 positioned in the head 14, as necessary.

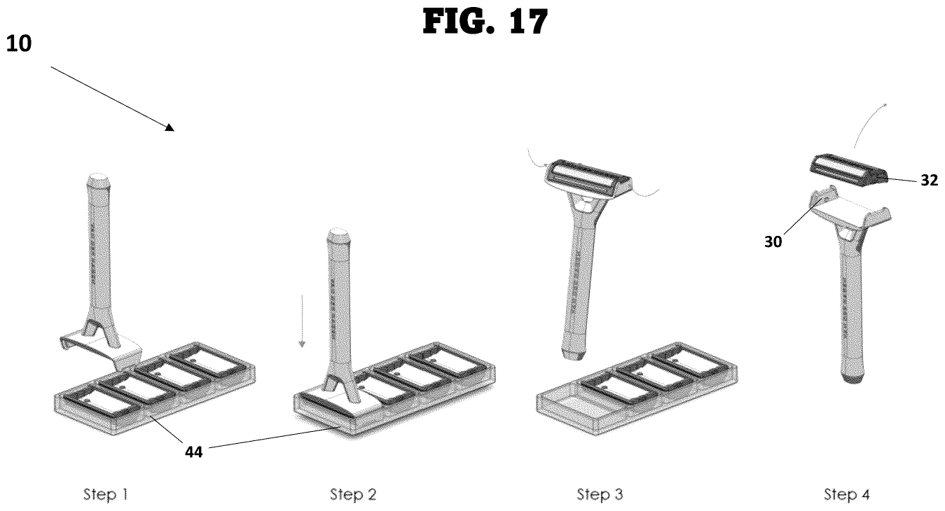

In both embodiments, the razor cartridge 20 is preferably engaged by simple, straight downward force into the cartridge 20 positioned within, e.g., a cartridge tray 44, as shown in steps 1 and 2 of FIGS. 9 and 17. Once sufficient downward force is achieved, the coupling members 30, 32 of the razor head 14 and cartridge, whatever described or known mechanism they might be, engage one another to secure the cartridge 20 to the razor 10, as illustrated in step 3 of FIGS. 9 and 17. At any time thereafter, the cartridge 20 may be removed, as shown in step 4 of FIGS. 9 and 17.

In the embodiments of FIGS. 4-11, the release mechanism 40 is comprised of a button 42 on the handle 12. In one sub-embodiment as previously described and shown in FIGS. 9 and 10, the release mechanism 40 is connected to at least one prod (or push) member 46 which moves upward from the base 36 via the button 42 to force disengagement of the cartridge 20 from the shaver head 14. In a second sub-embodiment shown in FIG. 11, the release mechanism 40 is connected to at least one lateral member 48 which moves outward to secure the cartridge 20 and moves inward to release the secured cartridge 20. This push-button release mechanism 40 may operate in a myriad of ways known to those of skill in the art, including spring-biased pins, hooks, or the like.

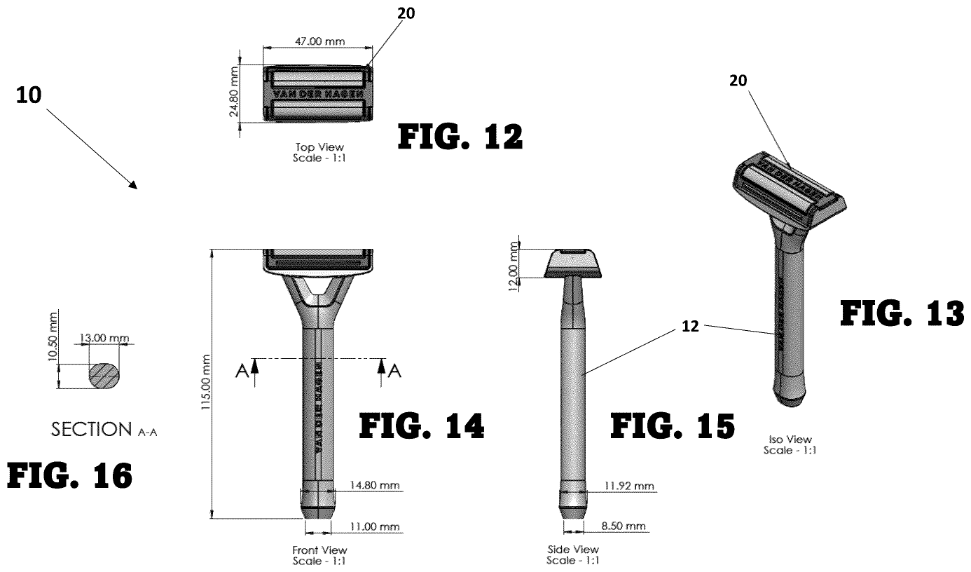

In the embodiment of FIGS. 12-17, the cartridge 20 is removed from the head by alternate means. It may be manually disengaged by the user exerting force on the cartridge 20. It may be disengaged by repositioning the cartridge 20 into a cartridge tray—e.g., the reverse of steps 1 and 2 in FIG. 17.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A handheld shaver comprising:
a handle;
a head positioned onto the handle to be substantially perpendicular to a longitudinal axis of the handle, the head comprising a first coupling member; and
a cartridge comprising a body having first and second slit openings on opposing edges, and a second coupling member functionally corresponding to the first coupling member for releasable attachment of the cartridge to the head, the cartridge further comprising at least one disposable double-edge razor blade having first and second cutting edges positioned within the body of the cartridge;
wherein each of the first and second cutting edges of the razor blade extend from the first and second slit openings in the body.

2. The shaver of claim 1, wherein the first and second coupling members are comprised of protrusions and recesses, respectively.

3. The shaver of claim 1, wherein the first and second coupling members are comprised of recesses and protrusions, respectively.

4. The shaver of claim 1, further comprising a release mechanism for detaching the cartridge from the head.

5. The shaver of claim 4, wherein the release mechanism comprises an actuator button and a movable mechanism to force the cartridge from the head of the shaver.

6. The shaver of claim 4, wherein the release mechanism comprises an actuator button and a movable mechanism for securing and releasing the cartridge from the head.

7. The shaver of claim 4, wherein the release mechanism comprises a button positioned within the handle.

8. The shaver of claim 3, wherein the cartridge is reusable when the razor blade is disposed.

9. The shaver of claim 1, wherein the first coupling member comprises one of either a male or female component and the second coupling member comprises one of either a male or female component oppositely corresponding to the first coupling member.

10. The shaver of claim 1, wherein the cartridge has a shaving edge on two opposing sides.

11. A handheld shaver comprising:
a handle;
a head positioned onto the handle to be substantially perpendicular to a longitudinal axis of the handle, the head comprising a first coupling member;
a cartridge comprising a body having first and second slit openings on opposing edges, and a second coupling member functionally corresponding to the first coupling member for releasable attachment of the cartridge to the head, the cartridge further comprising at least one disposable double-edge razor blade having first and second cutting edges positioned within the body of the cartridge; and
a release mechanism for detaching the cartridge from the head;
wherein each of the first and second cutting edges of the razor blade extend from the first and second slit openings in the body.

12. The shaver of claim 11, wherein the release mechanism comprises an actuator button and a movable mechanism to force the cartridge from the head of the shaver.

13. The shaver of claim 11, wherein the release mechanism comprises an actuator button and a movable mechanism for securing and releasing the cartridge from the head.

14. The shaver of claim 11, wherein the release mechanism comprises a button positioned within the handle.

15. The shaver of claim 11, wherein the cartridge is reusable when the razor blade is disposed.

16. The shaver of claim 11, wherein the first coupling member comprises one of either a male or female component and the second coupling member comprises one of either a male or female component oppositely corresponding to the first coupling member.
